(19) United States
(12) Patent Application Publication
(10) Pub. No.: US 2004/0208816 A1
(43) Pub. Date: Oct. 21, 2004

(54) Fullerene whisker and production process for fullerene whisker

(76) Inventor: Takahido Mashino, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/823,616

(22) Filed: Apr. 14, 2004

(30) Foreign Application Priority Data
Apr. 15, 2003 (JP) 2003-110087

(51) Int. Cl. C01B 31/02

(52) U.S. Cl. 423/445 B

(57) ABSTRACT

Provided are a novel fullerene whisker which can be expected to be applied to various uses as a new functional material and a process for efficiently producing the fullerene whisker described above. The above fullerene whisker is constituted from a fullerene derivative obtained by chemically modifying fullerene, and the fullerene whisker described above is produced by a process in which a good solvent solution dissolving a fullerene derivative obtained by chemically modifying fullerene with a malonic acid derivative such as dialkyl malonate in which an alkyl group has 1 to 4 carbon atoms is brought into contact with a poor solvent for the fullerene derivative described above to form a liquid-liquid interface and in which a whisker comprising the fullerene derivative is deposited in this liquid-liquid interface.

### BACKGROUND OF THE INVENTION

1. Field of the Invention

The present invention relates to a fullerene whisker and a production process for a fullerene whisker. More specifically, the present invention relates to a novel fullerene whisker comprising methanofullerene obtained by chemically modifying fullerene and a process for efficiently producing the fullerene whisker described above by a liquid-liquid interfacial deposition method.

2. Description of the Related Art

In recent years, attentions are paid to fullerene and a carbon nanotube as carbon having a new structure. Fullerene is a molecule in which sixty or more carbon atoms are put together to form a spherical closed shell structure. The carbon atoms themselves forming this fullerene are combined through a covalent bond, and the bond comprises a regular combination of a five-membered ring and a six-membered ring.

Among the fullerenes described above, C₆₀ fullerene which is known as representative has a soccer ball-like form in which 20 six-membered rings of carbon atoms are put together so that 12 five-membered rings are formed. A molecule obtained by increasing these six-membered rings to 30 rings is C₇₀, and it is known that large spherical molecules of larger C₇₆, C₇₈ and C₈₂ to C₂₄₀ and C₅₄₀ or long tubes can be formed.

It is known that such fullerenes have an exceptionally high reactivity for a compound having an aromaticity and that various substituents can be added to a double bond in a six-membered ring-six-membered ring-connecting part, and the number of these substituents added can be controlled to some extent by reaction conditions. Further, when plural substituents are introduced, position isomers are formed, and the kind and the forming ratio thereof are determined according to the kind of the substituents.

If a substituent is introduced into fullerene, not only a polarity and a solubility of the molecule change, but also sp² carbon is converted to sp³ carbon, whereby an electron state of the fullerene skeleton changes as well to a large extent, and a change thereof is observed according to the physical properties of the substituent introduced. It is clarified that these change the energy levels of HOMO (highest occupied molecular orbit) and LUMO (lowest unoccupied molecular orbit) and exert an influence on the oxidation-reduction potential and the formation of photoexcited active oxygen. Accordingly, fullerene is expanded in an application area to a large extent by chemical modification such as substituent introduction.

To be specific, methanofullerene obtained by chemically modifying C₆₀ fullerene, particularly methanofullerene having an organic group containing an oxygen atom on a side chain has usually a molecular size of 1 nm or less and is soluble in an organic solvent. However, if this is irradiated with an electron beam, it becomes insoluble in an organic solvent, and therefore it is tried to use the methanofullerene described above for an electron beam resist making use of this property (refer to, for example, Japanese Patent Application Laid-Open No. 143074/1999).

It has been clarified by the present inventors that fullerene derivatives such as methanofullerene obtained by chemically modifying fullerene with malonic acid have an anti-oxidative activity based on an electron donate-accepting reaction. Further, reported are applications thereof to a anticancer drug based on active oxygen formed by a photoexcited fullerene derivative, an anti-HIV drug based on an enzyme inhibiting activity of HIV protease, a genetic manipulation reagent based on a bonding ability with DNA and a solar battery and a photoelectric transfer device based on photoelectron transfer ability.

On the other hand, a whisker comprising fullerene is known (refer to, for example, Japanese Patent Application Laid-Open No. 1600/2003), but in this whisker, fullerene constituting it is not chemically modified. Accordingly, the physical properties and the electronic characteristics thereof are restricted, and the application range thereof is unavoidably restricted. For example, an electric conductivity of this whisker can be controlled only by a thickness of the whisker.

The present inventors have tried to chemically modify a whisker itself in order to expand the application range of this fullerene whisker, and they have found that it is difficult to chemically modify it because a whisker structure is liable to decay. Further, even if the above whisker could be chemically modified, it is difficult to control the number of substituents introduced, and it is considered to be difficult to obtain a uniform chemically modified whisker with good reproducibility.

### SUMMARY OF THE INVENTION

An object of the present invention is to provide a novel fullerene whisker which can be expected to be utilized to various uses as a novel functional material and a process for efficiently producing the fullerene whisker described above.

Intensive investigations repeated by the present inventor in order to achieve the object described above have resulted in finding that a whisker comprising a fullerene derivative such as methanofullerene obtained by chemically modifying fullerene, particularly a fullerene derivative obtained by chemically modifying fullerene with a malonic acid derivative such as dialkyl malonate can be expected to be utilized to various uses as a novel functional material and that a fullerene whisker can efficiently be obtained from a fullerene derivative such as methanofullerene obtained by chemically modifying fullerene with dialkyl malonate by a liquid-liquid interfacial deposition method. The present invention has been completed based on such knowledge.

That is, the present invention provides the following.

(1) A fullerene whisker of a fullerene derivative, wherein the fullerene derivative is obtained by chemically modifying a fullerene.

(2) The fullerene whisker as described in the above item (1), wherein the fullerene derivative is a methanofullerene.

(3) The fullerene whisker as described in the above item (2), the methanofullerene is obtained by chemically modifying a fullerene with a malonic acid derivative.

(4) The fullerene whisker as described in the above item (3), wherein the malonic acid derivative is dialkyl malonate in which an alkyl group has 1 to 4 carbon atoms.

(5) The fullerene whisker as described in the above item (1), having an average diameter of 100 nm to 1 μm and an (6) The whisker as described in the above item (1), wherein the fullerene derivative is obtained by chemically modifying C₆₀ fullerene.

(7) A production process for a whisker of a fullerene derivative comprising the steps of:

bringing a good solvent solution dissolving the fullerene derivative obtained by chemically modifying a fullerene with a malonic acid derivative into contact with a poor solvent for the fullerene derivative to form a liquid-liquid interface between the good solvent solution and the poor solvent and

depositing the whisker in the liquid-liquid interface.

(8) The production process for a whisker as described in the above item (7), wherein the malonic acid derivative is dialkyl malonate in which an alkyl group has 1 to 4 carbon atoms, and the fullerene derivative is a methanofullerene.

(9) The production process for a whisker as described in the above item (8), wherein the good solvent for the methanofullerene is a hydrocarbon base solvent.

(10) The production process for a whisker as described in the above item (9), wherein the hydrocarbon base solvent is at least one selected from aromatic hydrocarbon compounds, aliphatic hydrocarbon compounds and alicyclic hydrocarbon compounds.

(11) The production process for a whisker as described in the above items (8), wherein the poor solvent for methanofullerene is an alcohol base solvent.

(12) The production process for a whisker as described in the above item (11), wherein the alcohol base solvent is at least one selected from aliphatic monohydric alcohols having 1 to 6 carbon atoms.

### BRIEF DESCRIPTION OF THE DRAWINGS

FIG. 1 is a transmission type electron microphotograph of the whisker obtained in Example 1.

FIG. 2 is a high resolving power transmission type electron microphotograph and a harrow pattern of the whisker obtained in Example 1.

### DESCRIPTION OF THE PREFERRED EMBODIMENTS

The fullerene whisker of the present invention comprises a fullerene derivative obtained by chemically modifying fullerene. The fullerene used as a raw material for this fullerene derivative shall not specifically be restricted, and any of C₆₀, C₇₀, C₇₆, C₇₈, C₈₂, C₂₄₀ and C₅₄₀ fullerenes can be used. Among them, C₆₀ fullerene is particularly suited.

The fullerene derivative obtained by chemically modifying the C₆₀ fullerene described above includes, for example, methanofullerene represented by the following structural formula (I):

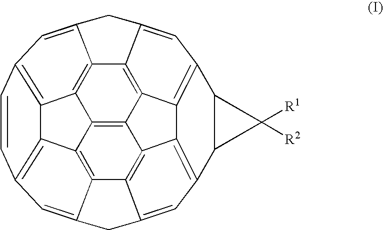

(wherein R¹ and R² represent an organic group, and they may be the same as of different from each other; and they may be combined with each other to form a ring structure).

This methanofullerene has a structure in which, as shown in the structural formula (I), a carbon atom is cross-linked with a network of a six-membered ring and a five-membered ring of carbon atoms constituting fullerene and in which side chains (R¹ and R²) are introduced into the carbon atom. In the structural formula (I) described above, a case in which cross-linking is made with the carbon atom at one portion is described, but this cross-linking may be made at plural portions. This methanofullerene can readily be produced by a process which has so far been publicly known.

In the present invention, among the methanofullerenes represented by the structural formula (I) described above, preferred is methanofullerene in which both of R¹ and R² are —COOR (R represents an alkyl group having 1 to 4 carbon atoms). The fullerene derivative such as methanofullerene can be produced by chemically modifying fullerene with dialkyl malonate in which an alkyl group has 1 to 4 carbon atoms. This production process shall be explained later in details.

The fullerene whisker of the present invention comprising the fullerene derivative such as methanofullerene has usually an average diameter of 100 nm to 1 μm and an average length of 1 to 100 μm. The average diameter and the average length described above are influenced by the kind of fullerene and the kind and the number of the substituents introduced into the above fullerene.

Next, the production process for the fullerene whisker according to the present invention shall be explained below with reference to an example in which methanofullerene is used as the fullerene derivative.

In the production process of the present invention, the desired fullerene whisker is produced by bringing a good solvent solution dissolving methanofullerene obtained by chemically modifying fullerene with dialkyl malonate in which an alkyl group has 1 to 4 carbon atoms into contact with a poor solvent for the methanofullerene described above to form a liquid-liquid interface between the good solvent solution described above and the poor solvent described above and depositing a whisker comprising the methanofullerene in this liquid-liquid interface.

The methanofullerene described above used in the process of the present invention can be obtained by chemically modifying fullerene such as C₆₀ fullerene with dialkyl malonate in which an alkyl group has 1 to 4 carbon atoms according to a method reported in, for example, ┌J. Chem. Soc., Chem. Commum.┘, page 1727 (1994).

To be specific, fullerene such as C₆₀ fullerene is dissolved in an aromatic hydrocarbon solvent such as toluene which is a good solvent for fullerene, and then a substantially equivalent mole of dialkyl bromomalonate and excess sodium hydride are added to the fullerene described above, followed by heating the mixture at 100 to 150° C. to carry out reaction for 30 minutes to 3 hours. This reaction can be terminated by adding acid such as sulfuric acid to the reaction system.

After finishing the reaction, the liquid is dried on anhydrous magnesium sulfate and subjected to silica gel column chromatography to carry out separation and refining, whereby C₆₀[C(COOR)₂] (R is an alkyl group having 1 to 4 carbon atoms) methanofullerene can be separated from unreacted C₆₀ fullerene. This reaction equation shall be shown below for a case in which C₆₀ fullerene is used as the fullerene.

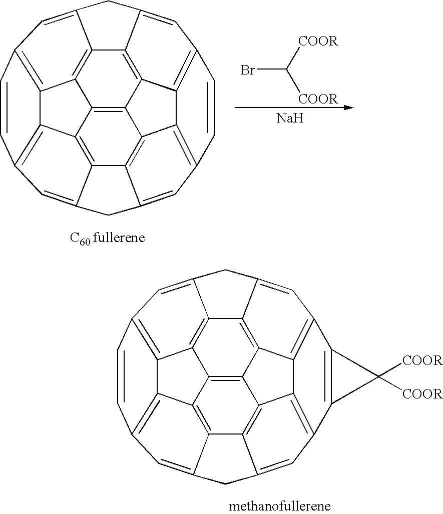

In the present invention, methanofullerene such as C₆₀[C(COOR)₂] thus obtained is dissolved in a good solvent therefor to prepare a solution. In this case, a hydrocarbon base solvent can be given as the good solvent for the above methanofullerene. This hydrocarbon base solvent can be selected for use from, for example, aromatic hydrocarbon compounds such as benzene, toluene, xylene and ethylbenzene, aliphatic hydrocarbon compounds such as pentane, hexane and octane and alicyclic hydrocarbon compounds such as cyclopentane and cyclohexane. These good solvents may be used alone or in combination of two or more kinds thereof.

In the present invention, the good solvent solution dissolving the above methanofullerene may be either a saturated solution or an unsaturated solution, and the saturated solution is preferably used from the viewpoint point that it is excellent in an ability to deposit methanofullerene.

In the present invention, the good solvent solution dissolving the above methanofullerene is brought into contact with the poor solvent for the above methanofullerene to form a liquid-liquid interface between the good solvent solution described above and the poor solvent described above. An alcohol base solvent is preferably used as the poor solvent which can form such liquid-liquid interface, and an aliphatic monohydric alcohol having 1 to 6 carbon atoms is particularly suited. To be specific, it can suitably be selected for use from methyl alcohol, ethyl alcohol, n-propyl alcohol, isopropyl alcohol, n-butyl alcohol, isobutyl alcohol, sec-butyl alcohol, tert-butyl alcohol, n-pentyl alcohol and n-hexyl alcohol. These poor solvents may be used alone or in combination of two or more kinds thereof.

A method for bringing the good solvent solution dissolving the above methanofullerene into contact with the poor solvent for the above methanofullerene to form a liquid-liquid interface shall not specifically be restricted, and capable of being used is a method in which the above poor solvent is slowly added to the good solvent solution dissolving the above methanofullerene. In this case, when the solvent system is constituted from such kind that the good solvent and the poor solvent are at least partially mixed with each other, it is particularly effective.

Such liquid-liquid interface can be formed at a step which is at least the one selected from an initial step of adding the poor solvent, a step of forming a nucleus of the methanofullerene, a depositing step of the methanofullerene and a growing step of the methanofullerene and can be maintained. The liquid-liquid interface is liable to be formed between the methanofullerene solution and the poor solvent by using the good solvent dissolving the above methanofullerene and the poor solvent having a different density from that of the good solvent.

Considering these things, a combination in which the good solvent is toluene and in which the poor solvent is isopropyl alcohol can preferably be given.

In the present invention, a suitable auxiliary may be added, if necessary, to the poor solvent described above in order to accelerate the deposition of the methanofullerene. Further, a metal wire can be used, if necessary, in order to accelerate the nucleus formation of the methanofullerene. For example, a copper wire, an aluminum wire, a gold wire and a stainless steel wire can be given as this metal wire.

Various conditions such as the kind, a purity and a use amount of the methanofullerene which is the starting material, the selection of the good solvent and the poor solvent, a use amount of the good solvent, an addition amount and an adding method of the poor solvent, the selection of the auxiliary, the formation of the nucleus, the addition of the nucleus, the growth of the nucleus, the formation and the maintenance of the liquid-liquid interface and the temperature can be set up for the deposition of the whisker constituted from the above methanofullerene.

In the present invention, supersonic treatment can be carried out, if necessary, at a room temperature for 1 to 30 minutes in order to effectively deposit the whisker constituted from the above methanofullerene.

Further, a metal catalyst or a metal oxide catalyst can be used in order to accelerate the crystal growth. In this case, copper, aluminum, iron and gold can be given as the metal catalyst. Lead titanate, lead zirconate, zirconium oxide, titanium oxide and lead oxide can be given as the metal oxide catalyst.

The whisker constituted from the above methanofullerene can be deposited at a room temperature, and it is advantageously deposited at a temperature of preferably −20 to 75° C., more preferably 10 to 30° C.

The fullerene whisker constituted from the fullerene derivative such as methanofullerene which is obtained by chemically modifying fullerene according to the present invention is considered to be applied to the following uses.

(1) The strength, the insulating property and the electric conductivity anisotropy can be changed by changing the kind and the number of the substituent introduced into the fullerene, and a novel carbon fiber can be developed according to the uses. For example, in a conventional whisker, an electric conductivity can be controlled only by a thickness of the whisker, but it can be changed to various extends according to the kind of the substituent.

(2) New materials can be developed by further chemically modifying the substituent bonded to the fullerene. For example, it is considered that a whisker constituted from fullerene having a positive charge can be a trap or a reservoir for a negative ion and that in contrast with this, a whisker constituted from fullerene having a negative charge can be a trap or a reservoir for a positive ion.

(3) A whisker constituted from a fullerene derivative such as plural kinds of methanofullerenes has the possibility of revealing a new function. For example, it is considered that whiskers constituted from fullerene having a positive charge and fullerene having a negative charge are alternately arranged because of an electrostatic interaction, and a positive charge and a negative charge are alternately arranged in this whisker, so that a very high electric conductivity can be expected.

(4) It is possible to provide a whisker with a function given to a fullerene derivative such as methanofullerene, and it becomes possible to develop, for example, a whisker having an anti-oxidative activity.

### EXAMPLES

Next, the present invention shall be explained in further details with reference to examples, but the present invention shall by no means be restricted by these examples.

### Example 1

(1) Production of Methanofullerene

C₆₀ fullerene 435 mg (0.6 millimole) was dissolved in 200 ml of dried toluene, and 144 mg (0.6 millimole) of diethyl bromomalonate and 216 mg (9 millimole) of sodium hydride were added thereto. Sodium hydride was not dissolved and stayed in a suspending state. Then, the mixture was heated to 130° C. to carry out reaction while confirming the progressing situation of the reaction by means of silica gel thin film chromatography (TLC), and after about 90 minutes passed, 8 ml of a 1 mole/liter sulfuric acid aqueous solution was added to terminate the reaction.

Next, this reaction liquid was subjected to drying treatment on anhydrous magnesium sulfate and then subjected to silica gel column chromatography (developing solvent toluene:hexane=1:1 in terms of a weight ratio), and C₆₀ fullerene which was the raw material and C₆₀[C(COOC₂H₅)₂] methanofullerene which was the target substance were eluted in order. This methanofullerene had a yield of 110 mg.

(2) Preparation of Whisker

C₆₀[C(COOC₂H₅)₂] methanofullerene obtained in (1) described above was dissolved in toluene to prepare a toluene saturated solution of C₆₀[C(COOC₂H₅)2]. Then, 100 parts by weight of isopropyl alcohol was slowly dropwise added to 100 parts by weight of this solution to form a toluene solution-isopropyl alcohol interface, and it was left standing still at a room temperature (23° C.) for 7 days, whereby a whisker constituted from the C₆₀[C(COOC₂H₅)₂] methanofullerene was deposited.

This whisker was separated by filtering and observed under a transmission type electron microscope [TEM, manufactured by Japan Electron Co., Ltd. ┌JEM-4010┘ (400 kV)].

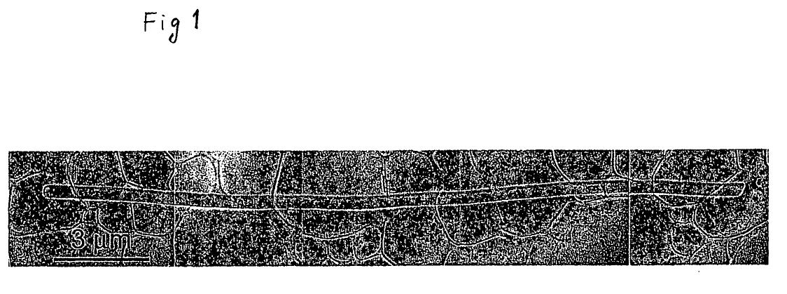

The TEM photograph of the whisker described above is shown in FIG. 1. The above whisker had an average diameter of about 400 nm and an average length of 21 μm and had a meandering form.

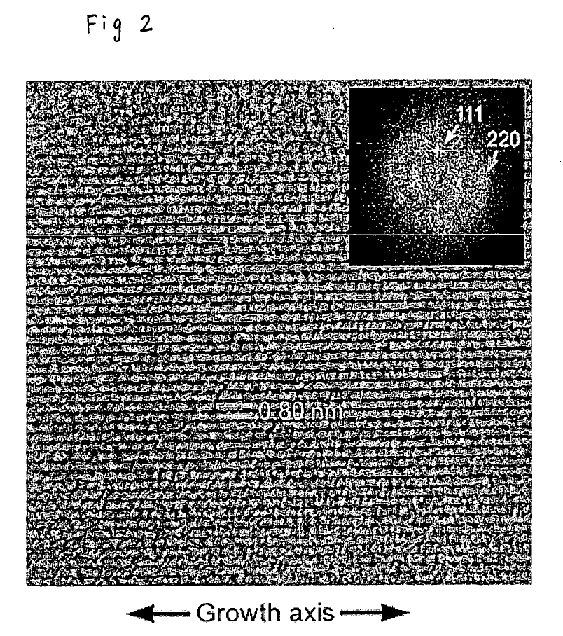

The high resolving power transmission type electron microscope (HRTEM) photograph of the above whisker is shown in FIG. 2. A part surrounded by a square is harrow pattern. The C₆₀[C(COOC₂H₅)₂] methanofullerene had an intermolecular distance of 0.96 nm in a growth axis, which was determined by FFT (fast Fourier transform) analysis. It was found that it was contracted by about 4% as compared with C₆₀ fullerene crystal.

The fullerene whisker of the present invention is a novel whisker comprising a fullerene derivative such as methanofullerene obtained by chemically modifying fullerene, and it can be expected to be applied to various uses as a new functional material.

Further, according to the process of the present invention, a fullerene whisker can efficiently be produced from a fullerene derivative such as methanofullerene obtained by chemically modifying fullerene with a malonic acid derivative such as dialkyl malonate by a liquid-liquid interfacial deposition method.

What is claimed is:

1. A fullerene whisker constituted from a fullerene derivative obtained by chemically modifying a fullerene.

2. The fullerene whisker as described in claim 1, wherein the fullerene derivative is a methanofullerene.

3. The fullerene whisker as described in claim 2, the methanofullerene is obtained by chemically modifying a fullerene with a malonic acid derivative.

4. The fullerene whisker as described in claim 3, wherein the malonic acid derivative is dialkyl malonate in which an alkyl group has 1 to 4 carbon atoms.

5. The fullerene whisker as described in claim 1, having an average diameter of 100 nm to 1 μm and an average length of 1 to 100 μm.

6. The fullerene whisker as described in claim 1, wherein the fullerene derivative is obtained by chemically modifying C₆₀ fullerene.

7. A production process for a whisker of a fullerene derivative comprising steps of:
bringing a good solvent solution dissolving the fullerene derivative obtained by chemically modifying a fullerene with a malonic acid derivative into contact with a poor solvent for the fullerene derivative to form a liquid-liquid interface between the good solvent solution and the poor solvent and
depositing the whisker in the liquid-liquid interface.

8. The production process for a whisker as described in claim 7, wherein the malonic acid derivative is dialkyl malonate in which an alkyl group has 1 to 4 carbon atoms, and the fullerene derivative is a methanofullerene.

9. The production process for a whisker as described in claim 8, wherein the good solvent for the methanofullerene is a hydrocarbon base solvent.

10. The production process for a whisker as described in claim 9, wherein the hydrocarbon base solvent is at least one selected from aromatic hydrocarbon compounds, aliphatic hydrocarbon compounds and alicyclic hydrocarbon compounds.

11. The production process for a whisker as described in claim 8, wherein the poor solvent for the methanofullerene is an alcohol base solvent.

12. The production process for a whisker as described in claim 11, wherein the alcohol base solvent is at least one selected from aliphatic monohydric alcohols having 1 to 6 carbon atoms.
